(19) United States
(12) Patent Application Publication
(10) Pub. No.: US 2021/0285590 A1
(43) Pub. Date: Sep. 16, 2021

(54) METHODS, SYSTEMS, AND APPARATUS FOR PROVIDING ACCESS FOR TELECOMMUNICATION CABLES IN UTILITY PIPING

(71) Applicants: Larry W. Kiest, JR., Fort Lauderdale, FL (US); Giacomo Conte, Galloway, OH (US)

(72) Inventors: Larry W. Kiest, JR., Fort Lauderdale, FL (US); Giacomo Conte, Galloway, OH (US)

(21) Appl. No.: 17/249,749

(22) Filed: Mar. 11, 2021

Related U.S. Application Data
(60) Provisional application No. 62/988,617, filed on Mar. 12, 2020.

(51) Int. Cl. F16L 55/26; H02G 1/08; H02G 3/04; G02B 6/44

(52) U.S. Cl. CPC F16L 55/26; H02G 1/08; F16L 2101/50; G02B 6/4459; H02G 3/04

(57) ABSTRACT

Cables, such as telecommunications cables, fiber cables, conduits, and the like, can be installed in existing pipe systems to avoid the need for trenches. However, to aid in keeping the cables out of the flow of the pipes of the pipe system, the cable or cables are positioned adjacent a wall of the pipe. To hold or otherwise secure the cables in place, aspects of CIPP pipe repair are used in place of mechanical fasteners. This can take many forms, including, but not limited to, curable resins, resin impregnated liners or liner straps, T-liners, gaskets, etc. The resin or resinous liners can be inflated towards the wall of the pipe to hold the cables in place between the curable resin and the wall of the pipe.

### CROSS REFERENCE TO RELATED APPLICATIONS

This application claims priority under 35 U.S.C. § 119 to provisional patent application U.S. Ser. No. 62/988,617, filed Mar. 12, 2020. The provisional patent application is herein incorporated by reference in its entirety, including without limitation, the specification, claims, and abstract, as well as any figures, tables, appendices, or drawings thereof.

### FIELD OF THE INVENTION

The invention relates generally to the introduction, movement, and/or placement of cables, fiber optics, telecommunication cables, and/or conduit to a pipe system utilizing trenchless technologies.

### BACKGROUND OF THE INVENTION

The background description provided herein gives context for the present disclosure. Work of the presently named inventors, as well as aspects of the description that may not otherwise qualify as prior art at the time of filing, are neither expressly nor impliedly admitted as prior art.

Many municipalities have buried infrastructure. Sewer systems are a buried infrastructure that provides access points such as manhole and cleanouts. The main sewer pipe extends between an upstream and a downstream manhole, and a number of service pipes extend laterally from the main pipes. These service/lateral pipes may extend to existing structures, such as buildings (residential, business, etc.). In many instances, the pipe systems are aged and require repair. Trenchless pipe repair methods are commonly used to repair or renew the pipe by accessing the pipe through access points. This access may also be used for installing conduits or cables to and through pipelines and avoiding the need for excavation.

For example, as technology advances, many cables (electrical, fiber, and the like) and other conduits are being developed and needed either in places of existing technology, or as a replacement thereto. This can take many forms. New communications cables (e.g., ethernet, coax cables, fiber cables, and the like) are required for much of the way people communicate. These may be in addition to or even replacing current cables, such as telephone cables. Still other types of cables are required for communication, electronics, information, and the like.

Similar to the repair of existing pipe systems, such as using cured in place pipe repair, the ability to access and navigate these pipe systems can be difficult. Often, due to technical difficulties, conflicting utilities, structural limitations, costs, or even aesthetic reasons, trenching to provide access to the systems is unavailable. Still further, it is ideal to place cables and other conduits underground, so as to provide protection.

Therefore, there exists a need in the art for methods, systems, and/or apparatus to provide access to and the placement of cables and/or conduits into existing pipe systems in a way that does not obstruct or otherwise affect the ability to use the pipes as originally designed in the system.

### SUMMARY OF THE INVENTION

The following objects, features, advantages, aspects, and/or embodiments, are not exhaustive and do not limit the overall disclosure. No single embodiment need provide each and every object, feature, or advantage. Any of the objects, features, advantages, aspects, and/or embodiments disclosed herein can be integrated with one another, either in full or in part.

It is a primary object, feature, and/or advantage of any aspects of any embodiments disclosed in the present specification to improve on or overcome the deficiencies in the art.

It is another object, feature, and/or advantage of any aspects of any embodiments disclosed in the present specification to provide systems, methods, and/or apparatus for securing one or more conduits in a pipe system without mechanical fasteners.

It is yet another object, feature, and/or advantage of any aspects of any embodiments disclosed in the present specification to introduce conduit into a pipe system with or without repairing one or more pipes of the system.

It is still another object, feature, and/or advantage of any aspects of any embodiments disclosed in the present specification to insert one or more conduits or cables (e.g., fiber optic cables or other telecommunication cables) in a pipe system without substantially blocking or otherwise obstructing any of the pipes of the system.

It is still a further object, feature, and/or advantage of any aspects of any embodiments disclosed in the present specification to provide cable access to one or more pipes of a system without needing significant access to the pipe system.

Any of the systems, methods, and/or apparatus disclosed herein can be used in a wide variety of applications. For example, they could be used during repair of a pipe, such as with CIPP pipe repair. They could also be used without pipe repair, such as to provide one or more cable access to a location without disruption or destruction of any infrastructure or external structures.

The systems, methods, and/or apparatus can be incorporated into systems or kits which accomplish some or all of the previously stated objectives.

According to some aspects, a method of positioning one or more cable conduits in a pipe system includes inserting the one or more conduits into a main pipe of the pipe system, moving the one or more conduits through the main pipe, and securing the one or more conduits to a wall of the main pipe by introducing a curable material such that the one or more conduits are between a curable material and the wall of the main pipe and expanding a bladder against the curable material until the curable material has cured.

According to at least some embodiments, the method further comprises moving at least one of one or more conduits into a lateral pipe off of the main pipe.

According to at least some embodiments, the at least one of the one or more conduits is secured in-place to a wall of the lateral pipe.

According to at least some embodiments, the method comprises bundling together a plurality of conduits to comprise the one or more conduits before inserting the conduits into the main pipe.

According to at least some embodiments, the method includes selectively unbundling at least one of the bundled conduits to move the at least one unbundled conduit into and through a lateral pipe.

According to at least some embodiments, the curable material comprises one or more of: a. a resin impregnated liner section having a length less than the length of the main or lateral pipe; b. a resin impregnated liner extending approximately the full length of the main or lateral pipe; or c. a curable resin positioned directly to the main or lateral pipe.

According to at least some embodiments, the method includes spacing a number of resin impregnated liner sections having a length less than the length of the main or lateral pipes along the length of the main or lateral pipes, and expanding a bladder at the sections to expand the liner and press the liner toward the pipe wall, allowing the liner sections to cure and secure in-place the one or more conduits in place.

According to at least some embodiments, the resin impregnated liner is inverted into the main or lateral pipes.

According to at least some embodiments, when the curable resin is positioned directly to the main or lateral pipe, an inverting bladder is positioned in the pipe to hold the resin in place until it is cured.

According to at least some embodiments, the method includes positioning the one or more conduits in the main pipe so as to avoid an opening into a lateral pipe.

According to additional aspects, a method of installing one or more conduits through a pipe system comprising a main pipe and one or more lateral pipes extending from the main pipe includes introducing the one or more conduits into the main pipe, moving the one or more electrical conduits through the main pipe, at a lateral pipe extending from the main pipe, inserting at least one of the one or more conduits into and through the lateral pipe, wherein any remaining of the one or more electrical conduits continue through the main pipe; applying a curable material to the one or more conduits in the main and lateral pipes; and pressing the curable material and the one or more conduits towards a wall of the main and lateral pipes until the curable material cures and hardens to secure in-place the one or more conduits in place at the wall of the main or lateral pipe.

According to at least some embodiments, the method includes repairing the main or lateral pipe with a CIPP liner.

According to at least some embodiments, the curable material comprises a curable resin impregnated in a liner.

According to at least some embodiments, the method includes inverting the resin impregnated liner into the main and/or lateral pipes with an inflatable bladder to press the resin impregnated liner and one or more conduits towards the wall of the pipes.

According to at least some embodiments, the method includes installing a gasket at a junction between the main and lateral pipe after the one or more conduits have been inserted into the lateral pipe.

According to at least some embodiments, the curable material comprises one or more of: a. a resin impregnated liner section having a length less than the length of the main or lateral pipe; b. a resin impregnated liner extending approximately the full length of the main or lateral pipe; or c. a curable resin positioned directly to the main or lateral pipe.

According to yet additional aspects, method of installing one or more conduits in a pipe comprises inserting one or more conduits into and through a pipe, navigating the one or more conduits around any openings or obstructions in the pipe, and securing the one or more conduits at or near a wall of the pipe by applying a curable material such that the one or more conduits are between the curable material and the wall of the pipe and allowing the curable material to cure and harden to hold the one or more conduits in place.

According to at least some embodiments, the method includes pressing the curable material towards the wall of the pipe during curing to provide a smoother interior surface once cured and hardened.

According to at least some embodiments, the curable material is applied continuously along the length of the pipe.

According to at least some embodiments, the curable material is selectively spaced non-continuous along the length of the pipe.

These and/or other objects, features, advantages, aspects, and/or embodiments will become apparent to those skilled in the art after reviewing the following brief and detailed descriptions of the drawings. Furthermore, the present disclosure encompasses aspects and/or embodiments not expressly disclosed but which can be understood from a reading of the present disclosure, including at least: (a) combinations of disclosed aspects and/or embodiments and/or (b) reasonable modifications not shown or described.

### BRIEF DESCRIPTION OF THE DRAWINGS

FIG. 1 is a sectional view of an exemplary pipe system.

FIG. 2 is another view of a pipe system being prepped for the installation of one or more conduits.

FIG. 3 is a view of the pipe system of FIG. 2 showing the positioning of the conduit with a robot through the pipe system.

FIG. 4A is an end sectional view of a portion of a main pipe with no lateral or service pipes and showing the location of a conduit therein.

FIG. 4B is an end sectional view of a portion of a main pipe showing laterals extending therefrom and a conduit positioned between the laterals.

FIG. 4C is an end sectional view of a portion of a main pipe with three lateral pipes extending therefrom and showing multiple conduit locations within the pipe.

FIG. 5 is a view of the pipe system of FIG. 2 showing the conduit positioned in the pipe system.

FIG. 6 is a view of a section of pipe showing a plurality of liner strips to secure the conduit in place.

FIG. 7 is a view of a section of a pipe showing the repair of the pipe with a liner and also the securing of the conduit in the pipe.

FIG. 8 is a view of a section of pipe showing another version of repair the pipe without a liner.

FIG. 9 is a view of the pipe system showing the securing of a conduit in the pipe system.

FIG. 10 is an end sectional view of a pipe section showing a plurality of conduits positioned and secured in-place at the invert of the pipe section.

FIG. 11A is an end sectional view of the pipe of FIG. 10 showing the application of a curable material to the plurality of conduits at the invert of the pipe.

FIG. 11B is a side sectional view of the pipe of FIG. 10 showing the application of a curable material to the plurality of conduits at the invert of the pipe.

FIG. 12 is a schematic view of another embodiment of a robot applying a curable tape to hold a conduit in place.

FIG. 13 is a view of the system of FIG. 12 curing tape in a pipe.

FIG. 14 is a view of a system similar to FIG. 12 moving through a pipe and applying tape to hold conduit in place.

FIG. 15 is a view showing the curing of the tape of FIG. 14.

FIG. 16 is a view of a pipe system with a plurality of tape straps used to hold conduit in place in the pipe.

Several embodiments in which the present invention can be practiced are illustrated and described in detail, wherein like reference characters represent like components throughout the several views. The drawings are presented for exemplary purposes and may not be to scale unless otherwise indicated.

### DETAILED DESCRIPTION OF THE INVENTION

The following definitions and introductory matters are provided to facilitate an understanding of the present invention. Unless defined otherwise, all technical and scientific terms used herein have the same meaning as commonly understood by one of ordinary skill in the art to which embodiments of the present invention pertain.

The terms “a,” “an,” and “the” include both singular and plural referents.

The term “or” is synonymous with “and/or” and means any one member or combination of members of a particular list.

The terms “invention” or “present invention” as used herein are not intended to refer to any single embodiment of the particular invention but encompass all possible embodiments as described in the specification and the claims.

The term “about” as used herein refers to slight variations in numerical quantities with respect to any quantifiable variable. One of ordinary skill in the art will recognize inadvertent error can occur, for example, through use of typical measuring techniques or equipment or from differences in the manufacture, source, or purity of components. The claims include equivalents to the quantities whether or not modified by the term “about.”

The term “configured” describes structure capable of performing a task or adopting a particular configuration. The term “configured” can be used interchangeably with other similar phrases, such as constructed, arranged, adapted, manufactured, and the like.

Terms characterizing sequential order, a position, and/or an orientation are referenced according to the views presented. Unless context indicates otherwise, these terms are not limiting.

Mechanical, electrical, chemical, procedural, and/or other changes apparent to one of ordinary skill in the art can be made without departing from the spirit and scope of the invention.

As municipalities grow and the infrastructures already exist, it is increasingly important to provide electrical, telecommunication, and other access to buildings and other structures, such as via cables, fiber optic lines, conduits, or the like. Such access may be required for new technology, such as via an electrical conduit or the like. An electrical conduit may be referred to as a tube used to protect and route electrical wiring into and between buildings or other structures. The conduit may extend from a base station or other location to the building or other structure to provide electrical information, telecommunications, or power thereto. For example, the conduit may house fiber lines/cables (fiber optics), coax lines/cables, cable lines, electrical power, or generally any other like service or telecommunication. In addition, it should be appreciated that the conduit may take many forms, including a composition thereof. Such composition may include, but is not limited to, metal, plastic, fiber, fire or fire clay. Still further, the conduits may comprise a rubber or rubber like material. The conduit may be substantially rigid, but flexible conduit can be used and intended to be considered as part of the present disclosure.

As the need to install the conduit can be in places where existing infrastructure and external structures exist, it may be difficult to install the conduit, especially without destruction, upsetting, or penetrating the ground. For example, concrete, grass, or other ground can be dug up or otherwise trenched to provide a location to bury the conduit. However, this is undesired, as it creates a socially negative impact on residents and business owners and potentially negative structural effect on the infrastructure and/or external structure. Therefore, another method of installing or otherwise providing conduits is to utilize existing buried infrastructure. Such infrastructures may take the form of pipe systems, including sewer pipe or other pipe systems. To do so, access is provided to the pipe systems and a conduit is installed from an access point, such as a manhole or the like, and is moved or otherwise installed through the pipe system to the end location, such as a building or other structure. However, it is not desirable to allow the conduit to simply be placed in the pipe structure without securing it in some manner. The securing of the conduit will provide safety therefore and otherwise protect the conduit, while maintaining full or substantial access to the pipe system such that obstructions do not occur therein.

Therefore, it is at least part of the objective of the embodiments of the present disclosure to provide for systems, methods, and/or apparatus for both installing and securing one or more conduits in a pipe system for providing a conduit access to an end location, such as a building or other structure. As will be understood, multiple embodiments and/or aspects will be provided herein. It should be appreciated that any aspect of any of the embodiments disclosed in the present disclosure may be combined with any of the other embodiments or other aspects thereof to provide even additional embodiments, which may not be explicitly stated herein. Still further, it should be understood that the use of the terms cables, conduits, wires, lines, cords, hoses, etc. should be considered to be overlapping. The use of one of the terms herein is meant to understand that it could encompass any or all of the different terms mentioned, as well as any equivalent thereof.

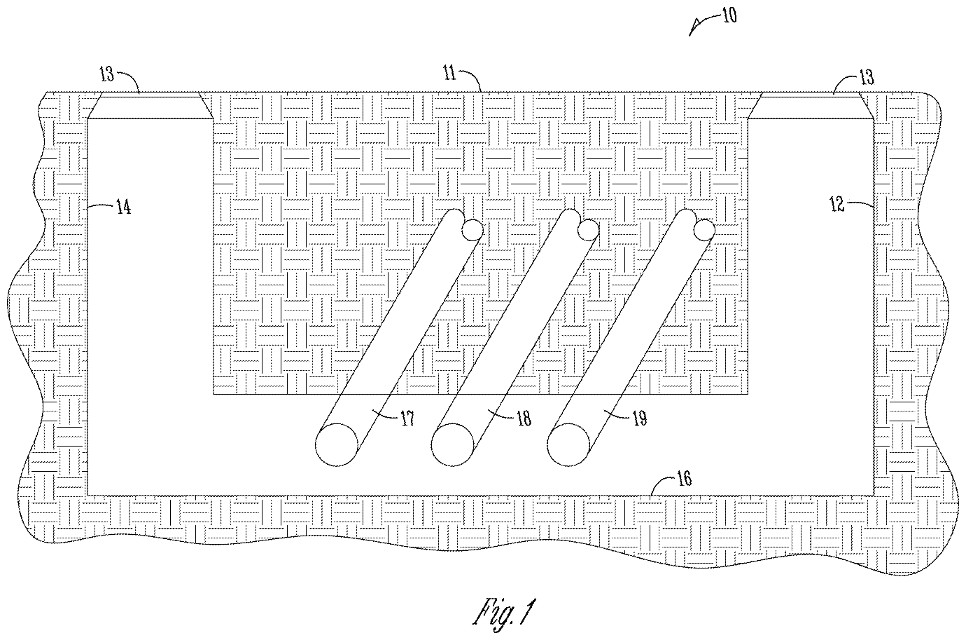

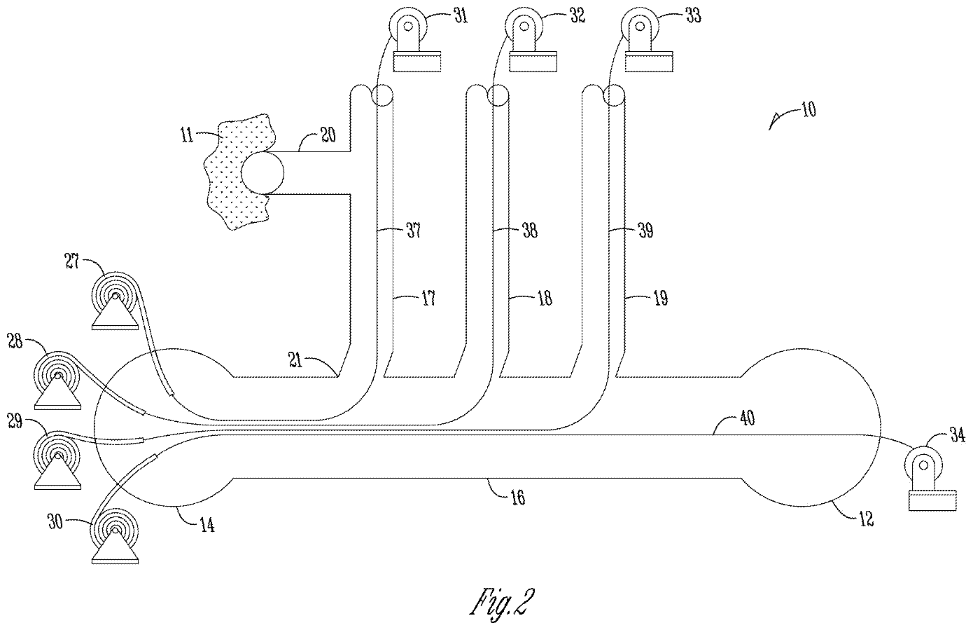

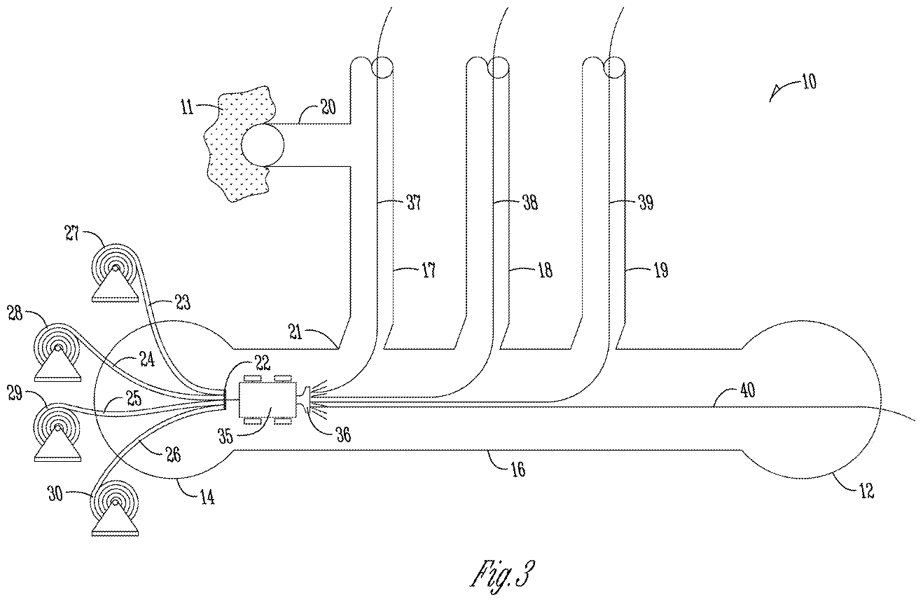

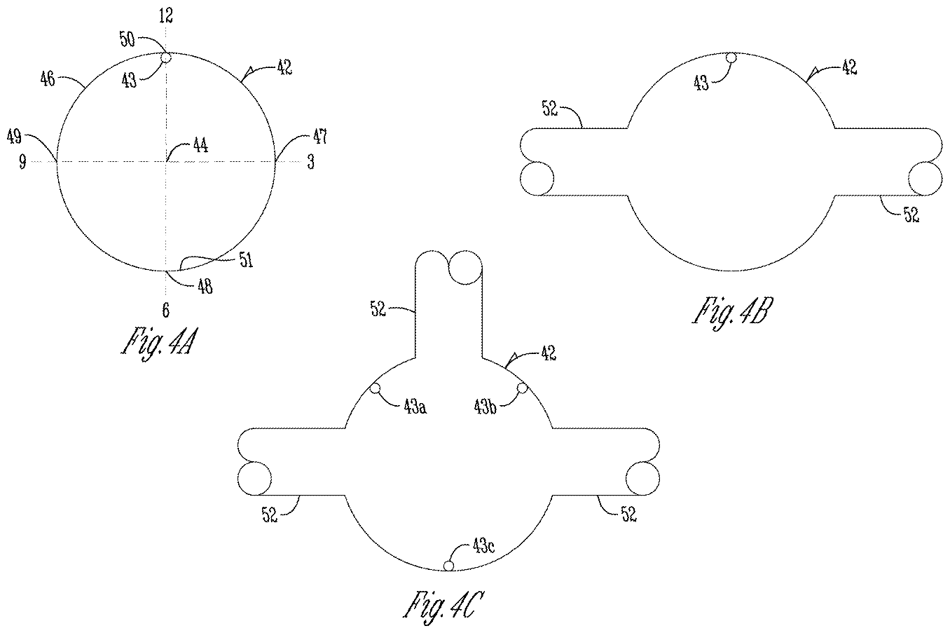

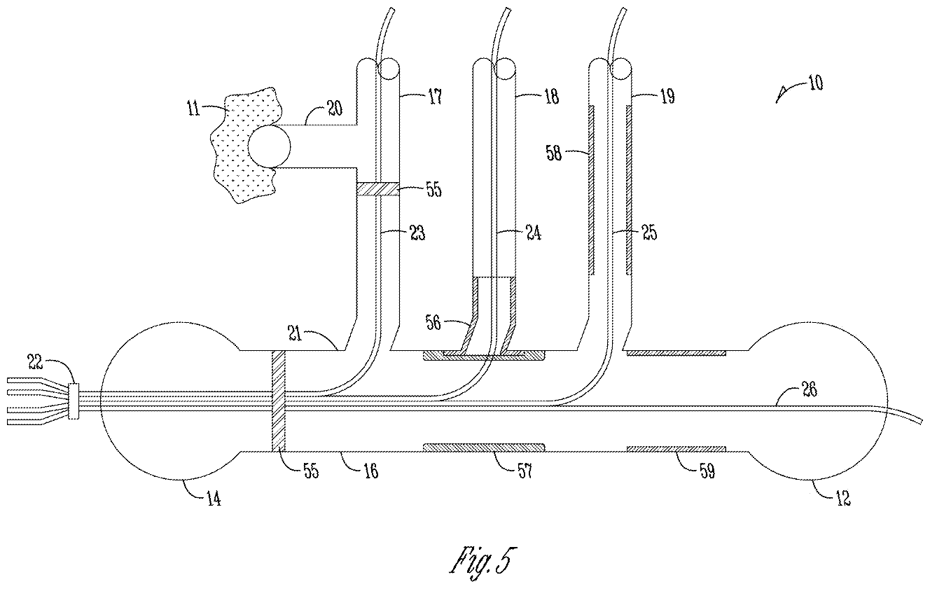

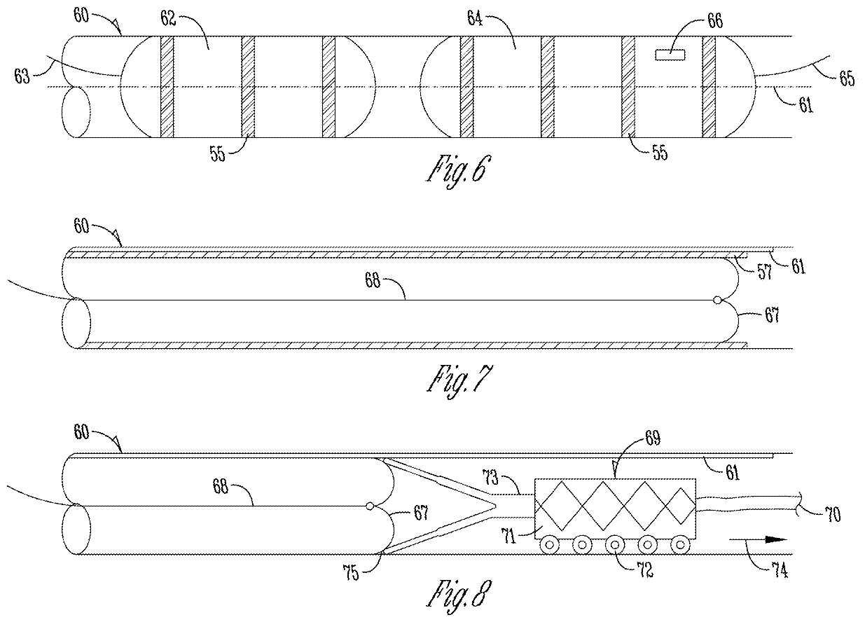

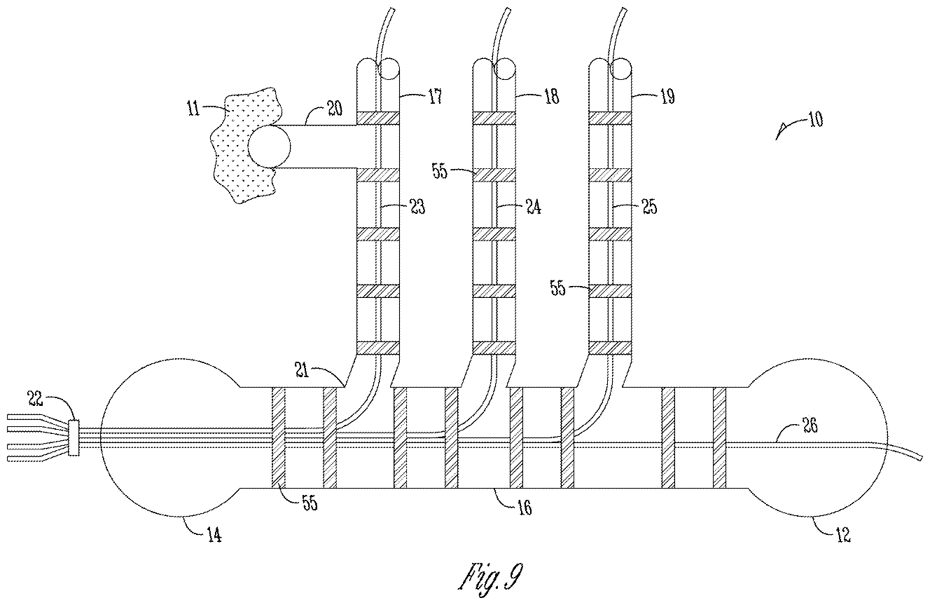

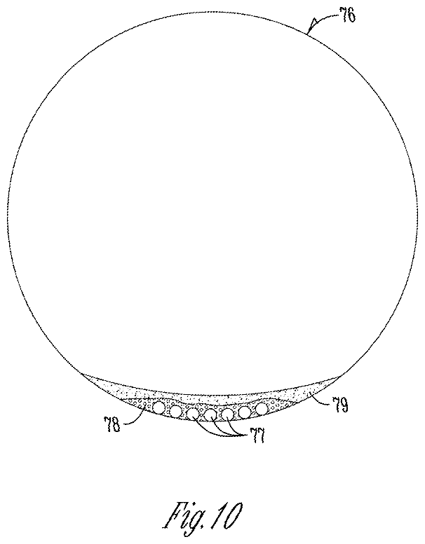

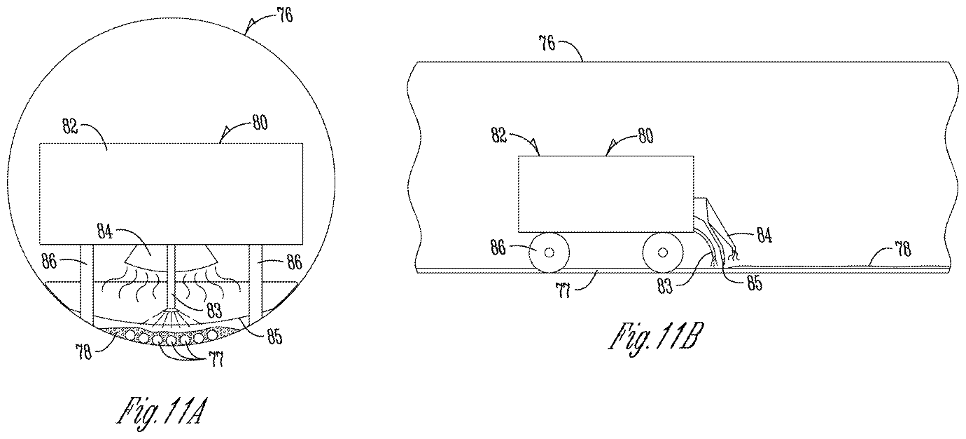

FIG. 1 is an exemplary sectional view of a pipe system 10. The pipe system 10 is not to be limiting on the present disclosure, and instead, is used for understanding a potential environment. The pipe system 10 includes an upstream manhole 12 and a downstream manhole 14. The manholes include manhole covers 13 at or near the grass, ground, or other surface, making the pipe system be located underground. Connecting the up and downstream manholes 12, 14, and extending generally therebetween is a main pipe 16. Extending from the main pipe are a number of lateral or service pipes. The service pipes shown in the pipe system 10 include a first service pipe 17, second service pipe 18, and a third service pipe 19. The number and/or orientation of the service pipe extending from a main pipe is not to be limiting to the invention, it is to be considered that any orientation and/or number of service pipes may be included, depending on the set up of a pipe system. However, for purposes of disclosure and understanding, the use of the three service pipes in FIG. 1 is provided. In conventional systems, the walls of the various components of the pipe system, such as that shown in FIG. 1, may comprise concrete, vitrified clay pipe, cast iron or like materials. As will be understood, according to at least some embodiments disclosed, the aspects of the invention include the repair of the pipe system during the introduction and securing of the conduit in a pipe system, such as may be referred to as cured in place pipe repair (CIPP).

A cured in place pipe (CIPP) is a trenchless rehabilitation method used to renovate existing pipelines. CIPP has applications in sewer, water, gas, and chemical pipelines of various diameters. As is known, the process of CIPP involves inserting and running a felt lining into a preexisting pipe subject of repair. Thermoset resin or other suitable material capable of curing and hardening is impregnated into a liner is exposed to a curing element to allow the liner to cure and harden, forming a new internal surface or wall of the pipe.

In addition, it should be appreciated that the introduction and/or the curing of a one or more CIPP liners in a pipe system need not be done at the same time of the installation of the conduits/fiber cables, and can be simply installed and secured in-place using any of the aspects as will be disclosed here.

FIG. 2 is another view of a pipe system 10 showing a preparation of the installation of one or more conduits. In the exemplary pipe system 10 shown in FIG. 2, there exists an upstream manhole 12 and a downstream manhole 14 being connected via a main pipe 16. A first service pipe 17, second service pipe 18, and third service pipe 19 extend generally from the main pipe 16. For exemplary purposes, a separate conduit may be installed in and through each of the service pipes and the main pipe, resulting in four conduit or conduit sets being installed therein. However, it should be appreciated that not all pipes require a conduit in all situations, and the infrastructure and/or external structure may determine the number of conduits needed for a particular system. It is preferred, but not required, that the conduits be installed from the downstream manhole 14 towards the upstream manhole 12. The conduits are formed of a bundle 22 at or near the downstream manhole 14. According to at least some embodiments, the conduits may be stored on reels, such as a first reel 27 for a first conduit 23, second reel 28 for a second conduit 24, third reel 29 for a third conduit 25, and a fourth reel 30 for a fourth conduit 26. The reels may store and easily unreel the lengths of conduits for installation in the pipe system.

Furthermore, as part of the preparation, a rope system may be utilized to back through the service pipes and main pipe to connect to each of the conduits. As shown in FIG. 2, a first rope 37 is connected at a first end to a first winch 31 and at another end to the first conduit 23 of the reel 27. Likewise, a second rope 38 has a second winch 32 at a first end and connected to the second conduit 24 at the second reel 28. A third rope 39 has a third winch 33 and is connected to the third conduit 25 at the third reel 29. Finally, the fourth rope 40 includes a fourth winch 34 and is connected to the fourth conduit 26 at the fourth reel 30. The backtracking of the rope system connected to the conduits will aid in pulling or otherwise positioning the conduits in the pipe system, as will be explained and understood. For example, the use of the winch system will aid in removing slack from the conduits to aid in holding the conduits at or near a wall of any of the pipes of the pipe system 10 in order to maintain the conduits out of the main portion of the pipe system to avoid obstruction therein. This is included through each of the pipes and at the junction 21 of any of the service pipes extending from the main pipe 16.

Furthermore, it should be appreciated that to provide access to any of the service pipes 17, 18 or 19, a clean out pipe 20 may be installed at the grass or ground 11. A clean out pipe 20, as is known in the art, provides access to a service pipe. Thus, the ropes may be positioned through a clean out pipe and into the service pipes wherein the winches are positioned generally at the entrance of the clean out pipe as well.

One aspect of the invention provides for the bundling of the conduits at or near the downstream manhole 14 before being positioned and strung through the pipe system. The bundling of the conduits creates a conduit bundle 22 for easier use and connection of the individual conduits to aid in the position of the conduit bundle 22 so as to position the conduits at a similar or common location in the pipe so as to mitigate obstruction therein. Therefore, according to some aspects of the invention, a system and/or method of bundling the conduits is provided. The conduits extending from the reels may be thermally bonded or coated, dipped, or otherwise provided with an adhesive, tape, or resin material, such as a bonding material. Such a configuration will hold the individual conduits in a bundle 22 as they move from the downstream manhole 14 and into the rest of the pipe system. However, the bond between conduits is breakable so as to allow an individual conduit of the bundle to separate from the rest. For example, as shown in FIG. 2, when the conduit bundle 22 reaches a location such as that of the pipe junction 21 between the main pipes 16 and the first lateral pipe 17, the first conduit 23 may be inserted into the lateral pipe 17. The winch 31 and rope 37 connected to the first conduit can be activated to break apart or otherwise separate the first conduit 23 from the conduit bundle 22 so as to allow the first conduit to be inserted into and through the first lateral pipe 17. The remaining conduits (conduit 24, 25, and 26) may be continued as a bundled 22 through the main pipe 16 to a location where next conduit will be separated from the bundle and moved through its own location. For example, this could occur at the second lateral 18 and the second conduit 24 can be broken away from the bundle and inserted through the second lateral 18. This can continue through the pipe system wherein a conduit is broken from the bundle at each lateral or service pipe until such final location, such as the upstream manhole 12, where a single conduit or bundle of conduits remains. Furthermore, the bundling of the conduits can be maintained through an entire pipe so as to maintain the conduits in a common or like location for securing in the pipe system.

FIGS. 3 and 4A-4C provide yet another aspect of embodiments of the present disclosure. As will be appreciated and has been disclosed herein, positioning the conduit or bundle of conduits can aid in mitigating or otherwise limiting the amount of obstruction within any of the pipes of the pipe system. Therefore, aspects of the invention provide for the selective positioning of a conduit or conduit bundle in one or more of the pipes. As shown in FIG. 4A, and exemplary pipe 42 is provided. The pipe 42 in FIG. 4A is circular and includes no service or lateral pipes extending therefrom. The pipe has an axis 44 generally at the center thereof and includes an upper pipe section 46 and a lower pipe section 51 (the invert). The crown and invert sections of the pipe can be identified generally by clock positions of the pipe, which are shown in the figure. For example, the pipe 42 of FIG. 4A includes a 3 o'clock position 47, a 6 o'clock position 48, a 9 o'clock position 49, and a 12 o'clock position 50. Thus, the upper pipe is generally any location of the pipe between the 3 and 9 o'clock positions of the pipe. The invert of the pipe 51 is considered generally the location at or near the 6 o'clock position 48 of the pipe 42. According to at least some embodiments, the preferred location of a conduit or bundle or conduits 43 is at the upper pipe 46, such as between the 3 o'clock position 47 and the 9 o'clock position 49 going in a counterclockwise direction from the 3 o'clock to the 9 o'clock. Still further, it is even more preferred that the location of the conduit or bundle of conduits be positioned at or near the 12 o'clock 50 of the pipe 42 (the crown). Having the conduit at said location will aid in limiting or otherwise mitigating blockage or obstruction within a pipe system.

FIG. 4B shows yet another exemplary depiction of a pipe 42, in which said pipe 42 includes lateral or service pipes 52 extending generally at the 3 and 9 o'clock positions. However, in such a configuration, the upper portion of the pipe 46 between the 3 and 9 o'clock positions is generally maintained such that the conduit or bundle of conduits 43 can still be positioned generally at or near the 12 o'clock position 50 or otherwise at the upper portion of the pipe between the 3 and 9 o'clock positions.

As shown in FIG. 4C, the pipe 42 includes a third lateral pipe extending generally from the 12 o'clock position of the pipe. In such a configuration, you are not able to position the conduit or bundled conduits at or near the 12 o'clock position. Therefore, you would need to maneuver the conduit or bundle of conduits 43 to different locations. The conduit could be positioned at any of the positions 43A, 43B, or 43C as shown in FIG. 4C, in which any said locations are avoiding an entrance to one of the lateral pipes 52, while still being at or near a wall of the pipe so as to prevent, limit, or otherwise mitigate blockage in the pipe 42. Again, it may be preferable to have the conduit or bundle of conduits at one of the positions such as 43A or 43B which are at the upper portion of the pipe between the 3 and 9 o'clock positions, however, the position 43C at the invert or near the invert 51 of the pipe may be allowable as well.

Still further, it is to be noted that a lateral or service pipe may extend from a pipe at generally any orientation, and so the positioning of the conduit(s) or bundle is preferred to be at a location that does not overlap an entrance to the service pipe.

Therefore, as shown in FIG. 3, additional aspects include the ability to position the conduit or bundle of conduits 22 in any of the pipes of the pipe system. To aid in doing so, a robot 35, otherwise known as a positioning robot can be provided and utilized. A robot 35 can be attached to or otherwise include a component that is connected to the bundle to lay or otherwise direct the location and positioning of the conduit or bundle of conduits in a pipe to avoid openings to pipes extending therefrom. Such a robot 35 can include wheels and a camera 36 or other information sensor so as to allow a remote user to operate the robot and maneuver the robot and thus the conduit or bundle of conduits attached thereto about the circumferential interior of a pipe to aid in positioning the conduit or bundle of conduits to avoid an opening to a service or other pipe therefrom. This can be done for each of the pipes of a pipe system.

FIG. 5 is a depiction of a pipe system 10 showing conduit positioned in the pipe system and various systems, methods, and/or apparatus for curing the conduit in the pipe system to secure the conduit in a non-mechanical manner and without the use of mechanical fasteners. As will be understood, the conduit can be secured in-place at, to, or near a wall of any of the pipes of the pipe system 10 in order to position the conduit out of the way in the pipe so as to otherwise mitigate obstruction therein. Still further, it should be appreciated that FIG. 5 is not limiting as to how the conduits can or will be secured in-place, and instead shows various examples of ways in which the conduit can be secured in-place using aspects of CIPP. For example, according to at least some aspects and/or embodiments of the present disclosure, one or more liner straps 55 may be utilized to hold and/or secure the conduit or conduit bundle placed in a pipe. In FIG. 5, a first strap is shown at a position in the main pipe 16 and another strap is shown in a lateral or service pipe 17. Such a method may be used when the pipe itself need not be prepared.

For example, short sections (for example 1-inch to 6-inch) of CIPP liner may be used to hold the conduit in place. Such an example is shown in greater detail in FIG. 6. After the conduit has been positioned in a pipe, the conduit is held in tension so as to position the conduit at or near the pipe. This can be done with the rope and winch system to aid in holding the conduit(s) in a taut manner. The plurality of liner straps 55 can then be positioned in the pipe. As will be understood, the straps can be positioned on a packer, plug, or bladder type material with desired spacing, and then moved to a position in a pipe where they are expanded towards the wall of the pipe to secure, in-place, the conduit(s).

The liner straps 55 can be impregnated with a resin or material capable of curing and hardening. Once the straps are positioned in a pipe section, a bladder, packer, plug, or other inflatable or expandable device can be used to outwardly press the straps towards a wall of the pipe, and the curable element is allowed to cure and harden, forming a portion of the pipe that is cured and hardened to hold the conduit in place. In addition, a curing mechanism, such as a chemical initiator and catalyst, light, steam, or hot water may be introduced to aid in the curing of the curable material impregnated into the liner strap 55 to aid in the curing of the strap. As shown in FIG. 6, the number of straps and/or spacing of the straps can be determined based on a number of factors. The composition of the conduit or conduit bundle is one factor. It is preferred to mitigate slack or spacing between the conduit and the wall of the pipe 60. Therefore, spacing the straps 55 in a way that will reduce slack of a conduit between adjacent straps 55 can be determined to provide the ideal spacing so as the conduit does not sag.

According to some embodiments, there might be approximately three feet (approximately one meter) between adjacent straps so as to reduce or otherwise mitigate sagging of the conduit or conduit bundle 61 in the pipe 60. However, such a spacing is not to be limiting, and the spacing may depend on the width of the straps, composition and stiffness of the conduit, and/or other factors that may be appreciated by those skilled in the art. Furthermore, to position the straps 55 in the pipe section 60 and/or to expand the straps during curing of the resin material, a plug, packer, or bladder may be used. FIG. 6 shows exemplary embodiments of different plugs 62, 64 according to aspects of the invention. A plug 62 may be fitted with multiple straps, for instance there are three straps in FIG. 6, before positioning in the pipe. The straps are positioned on the plug with the preferred spacing thereon. Once the plug and strap combination are positioned in the pipe 60, air, steam, or other fluid pressure can be provided via the conduit 63 to an interior of the plug 62 so as to expand the plug, thus pressing the straps outwardly towards the surface of the wall of the pipe. This can be maintained until such time as the curable material in the liner straps has cured and hardened, thus providing a secure method of securing a conduit to or near a wall to pipe.

Also shown in FIG. 6 is a second plug 64. The second plug 64 shows different aspects, including being a different size such as holding more straps 55 than the first or left-most plug 62. It should be appreciated that the plugs may be various sizes to allow for varying numbers of straps 55 to be attached and positioned thereto in the pipe 60. However, in either sort, the plug and straps positioned in the pipe and the plug is expanded, such as a conduit 65 with air, steam, or the like, and the plug presses the straps towards and to the surface of the pipe 60. The plug can then be removed and the same or a different plug with straps can be positioned in the pipe to secure an additional length of the conduit(s) therein. Also shown in the plug 64 FIG. 6 is a curing mechanism 66. The plug may be fitted with a UV light strip, steam source, or other mechanism for reducing the time of curing of the resinous material impregnated into the liner straps 55. The exact source 66 can be selected based upon the type of resin utilized in the strap.

Therefore, the use of plurality of straps can be provided and used to secure one or more conduits in a pipe or pipe system. Such an exemplary embodiment shown in FIG. 9, where each pipe of the pipe system 10 includes a conduit extending therein and cured generally to a wall of the pipe with the use of the straps 55. The straps can be sequentially placed and cured with the use of one or more plugs, as the plugs and straps move through each of the pipes of the pipe system so as to secure the conduits thereafter. This can be done all at the same time or at various sequential steps as the plug system moves through the pipe. Still further, it should be appreciated that an inverting bladder can be used with the straps 55 wherein the straps are positioned and the inverting bladder is sequentially moved through a pipe system to press and hold the straps 55 at or near the wall of the pipe until such time that the resinous material has cured and hardened. A single bladder extending generally from one manhole to the next through the main pipe can also be utilized to position a larger number of straps at a single time as well. This can be achieved by attaching the straps to the exterior of the bladder, pulling the bladder through the pipeline and inflating the bladder to press the straps towards and/or against the pipe wall until the curable material has cured. Another method includes attaching the straps to the interior of the bladder, inverting the bladder through the pipe and pressing the straps towards and/or against the pipe until the curable resin has cured. Therefore, the use of smaller straps allowing the straps to cure and harden are not to be limited or limiting on the disclosure.

According to additional embodiments and/or aspects of the invention, the conduit could be positioned during a repair of one or more pipes of a pipe system. For example, as shown in FIG. 5, liners can be positioned in main pipe such as a main liner 57, at the junction of the pipes, such as a CIPP lateral connection liner as described in ASTM F2561 56, in a lateral pipe, such as by a lateral liner 58, or without a liner and simply with the use of a curable resin or other material and no liner, such as shown by the section 59 in FIG. 5. The use of any of these components will provide for a repaired section of pipe, while also positioning one or more conduits between the liner and pipe, or between the resinous material and the pipe wall, securing the conduit in the pipe and out of the way to mitigate obstruction therein.

According to some examples, a conduit or fiber cable 61 is pulled through a main pipe, such as shown in FIG. 7. The main pipe may extend from a downstream manhole to an upstream manhole, and the conduit may be positioned to lay in the pipe invert. A robot, such as the robot 35 previously disclosed, having a conduit holder can be placed and preferably travels from the downstream manhole 14 towards the upstream manhole 12, and the conduit is threaded or otherwise positioned in the conduit holder. The robot is capable of lifting and rotating the conduit holder to any position in the pipe, including to the crown or upper portion of the pipe, which may be described as a clock reference region from 9 to 3 o'clock and anywhere in between. The process includes that the conduit is placed against an interior surface of the pipe 60 and extends along the length of the pipe 60 with the ability to robotically position the conduit so as to avoid placing the conduit over any opening of a service or lateral pipe connection. The robot moves through the pipes positioning the conduit, while at the same time a resin saturated tube (CIPP 57) is inverted into the pipe 60, pressing the conduit or fiber cables 61 against or towards the pipe wall. The face of the inverting liner 57 and/or bladder 67 utilized to expand the liner can be in communication with the robot, and either the robot stays within a specified distance from the inverting face, or the robot includes a bowl shaped apparatus that allows the robot to be pushed by the inverting face of the liner tube and/or the bladder maintaining physical communication. As the robot and inverting tube progress through the pipe 60, the robot can maneuver the position of the conduit 61 to avoid side service connections. The inflated resin impregnated tube cures to form a seamless new pipe with the conduit or fiber cable 61 imbedded between the host pipe 60 and the CIPP to avoid obstructions and flow therein.

In addition, it should be appreciated that the CIPP will cover any service connection and a robotic cutter can be used to grind the liner away at the opening in the main pipe to reinstate the service connection, such as shown at the juncture 21 in the Figures. If the conduit or fiber cable located in the main pipe is positioned within the service pipe opening, the conduit can cause an obstruction and inhibit flow and the robotic grinding would likely damage the conduit. Therefore, the method of positioning the conduit in the main pipe with the robot can aid in avoiding such an outcome such as a blocking service connection while securing the conduit to the pipe without any mechanical anchoring device.

In a similar manner, a preliner tube can be used in place of a CIPP. In such a situation, the preliner is inverted into the pipe by fluid pressures carrying a conduit or fiber cable to the pipe wall, providing the preliner maintains inflation pressing tightly towards the pipe wall. As disclosed herein, when the robot is in communication with the inverting preliner, the robot can position the conduit to a fiber cable as to avoid covering a side service connection. The preliner is preferably made of an impervious material such as PVC, a PE, a PP, TPU, or similar thermal plastics. A resin absorbent layer may be laminated to the interior surface of the preliner tube when the tube is inverted into the pipe. Alternatively, the preliner may be clear or translucent, allowing a visual confirmation of the position of the preliner when inverted into the pipe. The preliner is inverted into the pipe from a pressure vessel or pressure apparatus that causes the preliner tube to invert through the pipe. The inverting apparatus includes a port where a robotic rotary spraying apparatus connected to a hose is inserted through the interior of the inflated pre-liner tube. The rotary spraying apparatus passes through the inflated preliner, keeping pressure maintained without fail to ensure the conduit remains in position between the pipe and the preliner. The rotary spraying apparatus applies a uniform layer of fast setting thermoset resin to the interior surface of the preliner tube. The resin can be adjusted to cure within minutes, forming a new rigid resin liner or pipe within the preliner. The thickness of the resin can be adjusted to improve physical structural properties of the new resin pipe. The impervious preliner provides water tightness of the new resin pipe and secures the conduit in the desired position in the pipe such that the conduit does not cover a side service connection.

An added benefit for the process of inverting a tube to position a conduit (or some sort of other telecommunication cable) in the crown area of a sewer pipe is the ability to keep the conduit or fiber cable out of the flow line without the use of any mechanical anchoring device. Since the conduit or fiber cable is not in the flow line, there is no or little obstruction or little restriction to the flow. It should be noted that the interior of the preliner is clean and/or dry so as to apply the resin, unlike the pipe surface of a sewer pipe. It should also be noted that the preliner process thus described herein would work with the conduits being positioned in the invert of the pipe, as has been disclosed and described herein.

Other options for providing the conduit through one or more pipe sections include laying a conduit or conduits 61 in a portion of the pipe, and applying a resinous, cementitious, or other similar material that can be pumped and cured to a solid surface or the conduit. One such example is shown in FIG. 8. As shown in FIG. 8, the conduit 61 has been positioned generally at the crown or upper portion of the pipe 60. The conduit 61 is held in tension thereat. An inverting bladder 67 including a rope 68 is inverted into the pipe 60 thus pressing the conduit towards the wall 60 of the pipe. Ahead of the inverting face of the bladder 67 is a robot 69. The robot 69 may be an extruding robot that includes one or more resin inputs 70 that provide resin to a body 71 of the robot. Wheels 72 aid in moving the robot through the pipe, such as in the direction of the arrow 74 in FIG. 8. At an opposite end of the robot 69 are extruders 73, which may be rotary extruders such as those shown and/or described. The extruders allow the extrusion of the resinous material at or near the inverting face of the bladder 37, wherein the resinous material that has been extruded is pressed towards the wall of the pipe 60 by the inverting bladder. This extrusion and pressing of the bladder presses the conduit 61 between the extruded material and the wall of the pipe so as to position the conduit and secure the conduit at or near the wall of the pipe, thus positioning the conduit out of the passageway of the pipe.

Another aspect for protecting the conduit at a service connection is an insert constructed of non-cutting materials that is inserted into the side service connection. Such a configuration can be positioned at a junction between a service pipe and a main pipe. An insert includes a groove for a conduit to pass through. The insert sandwiches the conduit between the host pipe and the insert. The insert can be made of non-cutting material, such as a ceramic, stainless steel, or other suitable non-cutting material. In such a case, the conduits would be strung through the main pipe and up into each service connection. Next, the conduit would comprise a non-cutting material at the service connection or a protective insert of a non-cutting material is positioned into each service connection. A mainline CIPP is installed (preferably by an inversion technique) extending from one manhole to the opposite manhole. The service connection is reinstated by use of a robotic cutter. A CIPP can be installed in the service pipe preferably using an inversion technique where the service pipe CIPP is installed from within the main pipe and extends up the lateral pipe to a building or predetermined location. Such a lateral connection liner can be identified as described in ASTM F2561 56 is shown in FIG. 5. Gaskets or other materials can be used with the CIPP liner to ensure water tightness at or near the juncture between the main and lateral pipes.

An alternative method is the use of a preliner in a resin pipe applied to the interior of an inflated preliner as disclosed herein to secure the conduit in the pipe invert where the conduits branch off and extend up the service pipe up to their respective building. The conduit can be made of a non-cutting material or an insert can be inserted into the service connection made of a non-cutting material in order to protect the conduit from damage as the service connection in the mainline resin pipe is cut open.

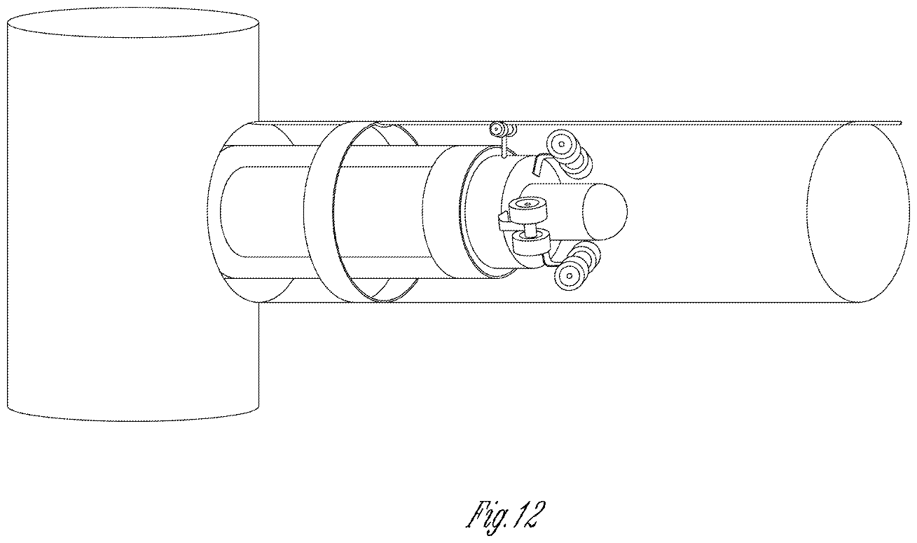

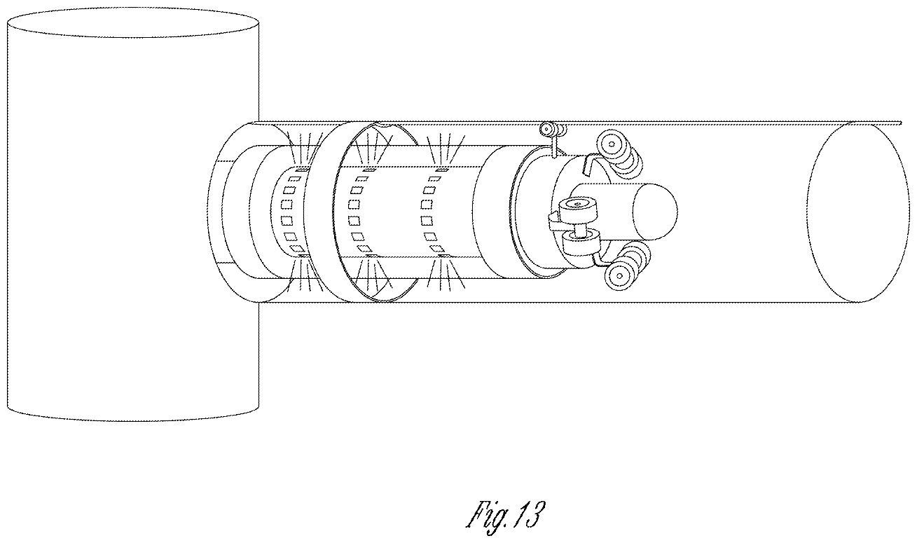

FIGS. 10, 11A, and 11B show yet additional systems, methods, and/or apparatus for positioning and securing one or more conduits 77 into a pipe 76. According to such embodiments, one or more conduits can be laid or otherwise positioned at or near the invert of a pipe, and a resinous, cementitious, or similar material can be pumped and cured to a solid surface over the conduit or conduits so as to form a new invert that encapsulates the conduits and provides a new smooth invert that improves the flow rate in the pipe. Sewers often have offset pipe joints that cause obstruction to the gravity flow and reduce the cross-section of a pipe. If a 10-inch pipe has dropped 1-inch, the cross-section is reduced to 8-inches because the 1-inch offset at the pipe inverted is mirrored at the pipe crown. In this case, the offset pipe joints can be milled downed using robotic cutting devices such as a Talpa manufactured by Schwalm Robotics. The milling of the offset joints maximizes the cross-section of the of the pipe and provides a new invert.

For example, as is shown in FIGS. 10, 11A and 11B, a number of conduits 77 positioned are generally at or near the invert of the pipe. A robot 80 is provided in which the robot includes wheels 86 that are positioned to be on either side of the conduit or bundled conduits 77. The robot includes a body 82 for receiving a resinous or cementitious material capable of curing and hardening. A resin tube 83 is provided to place the resinous material on or over the conduit 77 in the pipe. A curing element 84, such as a UV lighting source can be provided to cure the resinous material that has been applied thereto. In addition, a trowel tool 85 can be provided in order to smooth out the resin that has been applied thereto to form a generally smooth invert. As shown in FIG. 10, the trowel can be used to provide a substantially flat resinous material 78 or an arched resinous material 79 so as to correspond with the circular shape of the pipe 76.

Still another method for providing conduit through a sewer point includes grinding or milling a groove in the pipe invert to provide a channel for placing a conduit or conduits or fiber cable(s). The channel can be designed to not penetrate through the entire pipe wall. For example, an exemplary pipe may have a 1-inch thick pipe wall, and the channel can be milled using a robotic milling device at a desired depth of approximately 0.7-inches. The milled channel can extend from one manhole to an adjacent manhole connected to the pipeline. The channel may extend from the downstream manhole through the upstream side of the sewer pipe and continue up and into a service pipe. When the channeling extends from the downstream manhole to a service pipe, there could be an independent conduit for each service pipe. For example, if there were six service connections in a manhole to manhole pipe run, then there would be six conduits positioned in the milled channel located in the main pipe invert. The milled channel would branch off at each service connection extending up into the lateral pipe, where the channel would terminate at least several inches up into the service pipe at which point the conduit would come up out of the channel and simply lay into the invert of the service pipe extending up to the building the service pipe is providing service. The conduit remains protected down in the channel in the service connection to protect the conduit during robotic cutting if CIPP lining is used to rehabilitate the pipe. Otherwise, the conduit may be cut by robotic cutting.

After the milling has been completed, the conduits can be positioned in the channel and up into each respective service pipe, the main line is lined using CIPP, the service connections that are robotically reinstated, and the lateral pipes are lined using CIPP. Hydrophilic gaskets, such as described in ASTM F3240 and F2561, or other approved gaskets, may be used to ensure the CIPP is sealed at manhole connections and service pipe connections.

Still another aspect of the invention is the placement of conduits or fiber cables that are positioned in the main pipe invert extending from one manhole to the opposite. A CIPP liner is installed embedding the conduits between the host pipe and the CIPP. The conduits are small in diameter or have a flat shape so as to minimize any perfection in the CIPP caused by the size of the conduit transferring through the CIPP wall. The conduits may also run from a manhole (preferably the downstream manhole since the service pipes are usually lined in the direction of the flow) in the upstream direction to a service pipe, where the conduit/fiber cable turns and passes through the service pipe extending up to the building the sewer pipe that is providing service. Next, a liner (preferably CIPP) can be installed in the main pipe embedding the conduits/fiber cables between. The liner will rehabilitate the sewer pipe extending the service life of the pipe for at least another 50 years. It may be necessary to protect the conduit that branched off the main line and that extends into the side service pipe due to the robotic cutting device that is used to reinstate a hole in the main line CIPP. To prevent or otherwise mitigate the conduit being damaged, the conduit or a section of the conduit located at the service connection can be made from a material that resists cutting. Such suitable non-cutting materials may comprise stainless steel or other suitable non-cutting materials. The conduit may be made of a flexible corrugated stainless steel conduit as well. So as to mitigate the damage due to the reinstation of the pipe.

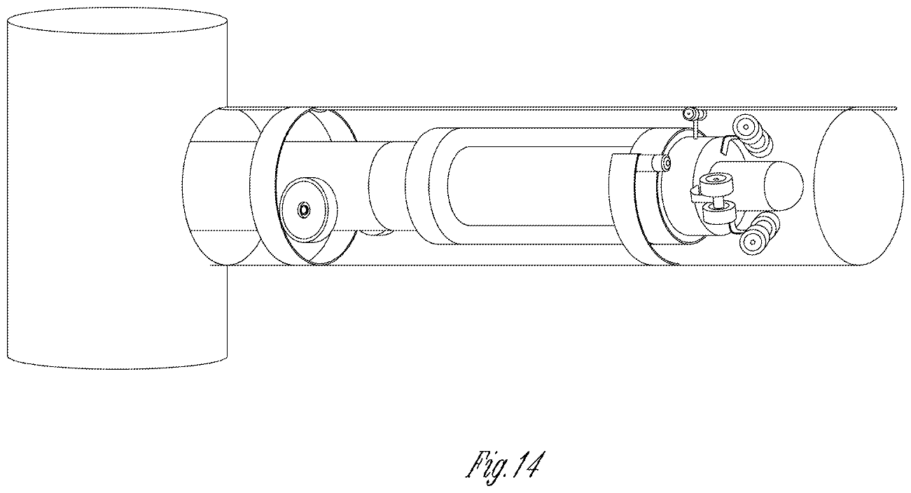

Still further, it is to be appreciated that any of the aspects and/or embodiments as shown and/or described herein could include the use of cured-in-place tape. For example, at least FIGS. 5, 6, and 9 disclose the use of straps 55 to hold portions of the conduit in place. The straps or strap-like members could be replaced with tape that has been saturated with a curable resin, similar to liners. According to at least some aspects, an entire roll of tape could be saturated with the curable resin. To place and hold the conduit, a robot, such as any of those shown and/or described herein, is mounted or otherwise associated with the tape, similar to how packing tape is mounted in a packing tape housing. Such an example is shown generally in FIGS. 12-16. The figures show a robot being positioned in a main pipe via a manhole (FIG. 12), which a conduit in the pipe.

After the conduit(s) is positioned in a pipe, such as the full pipe or a section thereof, the robot would enter the structure (FIG. 12). Other wheels would be used to move the robot in the pipe. The robot would be used to place the tape against the pipe and conduit, rotating the tape about the circumference of the pipe while pressing the same toward the pipe wall. A portion of the robot would hold the conduit in place, such as is shown in FIG. 12. This will press the conduit toward the wall as well and will hold the conduit between the tape and the wall. The resin saturated tape would then be cured to hold the tape and conduit in place, such as shown in FIG. 13, where an inflatable bladder or plug is holding the tape/conduit in place during the curing. For example, some aspects and/or embodiments include that the resin is UV or other light-curable. In such a situation, the robot could include a light structure, such as a UV light, which would be used to cure each segment/section/strap of tape after it has been applied to hold the conduit against the wall of the pipe. Thus, the tape would essentially be cured or curing as it is positioned at the wall of the pipe. However, the stiffness of the tape, or other properties of the tape could be adjusted, such that the tape could be formed as a semi-solid ring once positioned in the pipe. The tape would be able to hold itself in place until the robot is able to speed up the curing of the same.

In addition, it is to be appreciated that the resin could be heat-cured, and a steam or other heat source be used to cure one or more of the tape straps in the pipe to cure the resin and more permanently place the conduit in position in the pipe. The heat could come from the robot or from another source, such as similar to the steam used to inflate bladders.

The rotational application of the tape by the robot will create the strap 55 or strap-like application. The tape could be cut or otherwise sized such that a length of tape is used for specific diameters of pipe. This can be repeated along the length of the pipe or section of pipe to create a pipe that would look similar to that shown in FIGS. 5, 6, and 9, but instead of liner straps, there would be tape sections forming the strap-like portions to hold the conduit in place. For example, a single robot could be loaded with enough tape or tape sections to create a sufficient number of tape rings through a pipe. This would reduce the need to remove the robot in a pipe as the robot moves to resupply the robot with additional tape as it moves along the length of the pipe.

Still further, while it has been included that the tape is used to create strap-like sections, this could be expanded such that the tape creates longer/wider sections in the pipe. For example, the rotational application of the tape by the robot could be complete as the robot moves through the pipe. This could be timed such that a solid length of the pipe is covered by the tape, or a spiral application of the tape covers the interior of the pipe as the robot moves. In any sense, the tape will be cured or otherwise allowed to cure to hold the conduit in place in the pipe.

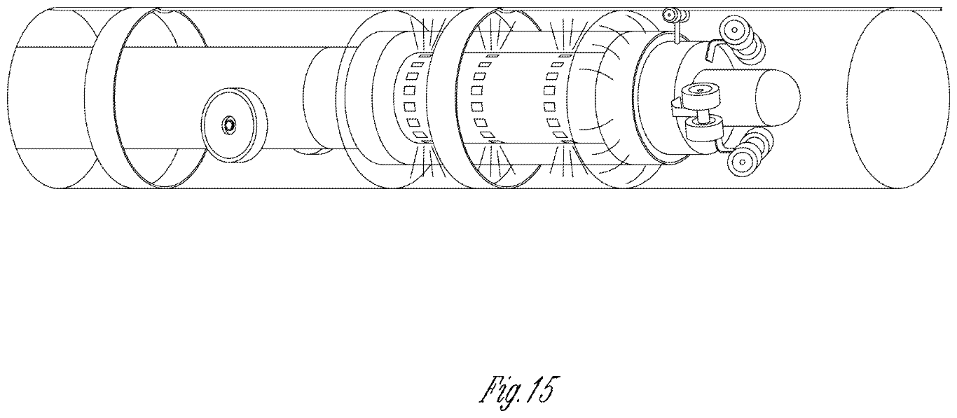

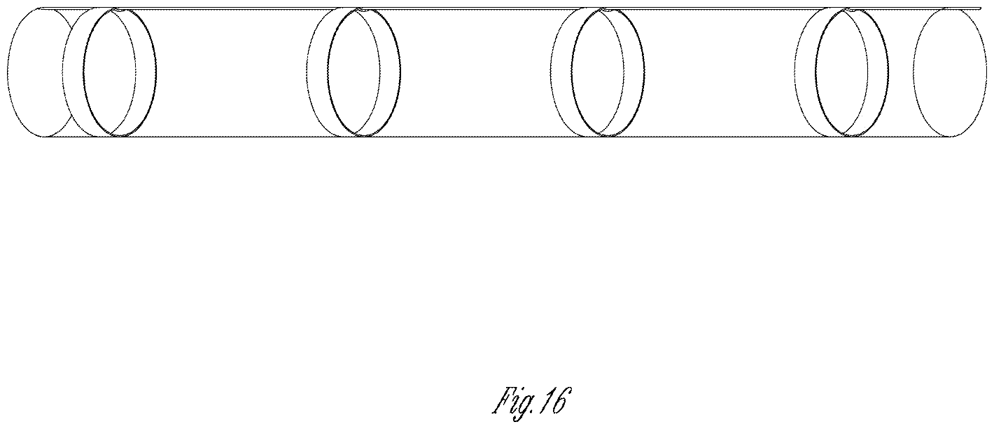

FIG. 14 shows the robot moving through the pipe, At another location, another strap of tape is being placed to hold the conduit in place at the pipe wall. FIG. 14 shows a partial amount of tape being applied towards the pipe wall in a circular manner. After the tape is applied, the robot again holds the tape in place and cures the same (see, e.g., FIG. 15).

As included, the process is repeated through a pipe section. A finished pipe section is shown in FIG. 16, where three straps of tape have been cured in place to hold the conduit in place at or near the pipe wall and out of place of the flow of the pipe. The number of tape straps and the distance between the same can be selected based upon a number of factors, including, but not limited to, the type, size, or weight of the conduit, the length of the pipe, the width of the tape strap, the stiffness of the tape, the number of conduits, any structural issues with the pipe, or the like.

Therefore, numerous aspects, embodiments, and the like have been provided for the installation of a conduit or conduits and a pipe and securing the conduit in the pipe so as to minimize the obstruction of flow therein. As has been stated herein, any of the aspects according to any of the embodiments may be combined with any of the other aspects, even those not explicitly stated, so as to provide additional embodiments that may be obvious to those skilled in the art. The disclosure is not to be limited to the particular embodiment described herein.

The present disclosure is not to be limited to the particular embodiments described herein. The scope of the invention is defined only by the appended claims, along with the full scope of equivalents to which such claims are entitled.

1. A method of positioning one or more conduits in a pipe system, the method comprising:
inserting the one or more conduits into a main pipe of the pipe system;
moving the one or more conduits through the main pipe;
securing the one or more conduits to a wall of the main pipe by:
introducing a curable material such that the one or more conduits are between the curable material and the wall of the main pipe; and
curing the curable material.

2. The method of claim 1, wherein the step of securing the one or more conduits towards a wall of the main pipe comprises applying a tape including the curable material to the wall of the main pipe such that the one or more conduits are between the tape and the wall.

3. The method of claim 1, further comprising expanding a bladder against the curable material until the curable material has cured.

4. The method of claim 1, further comprising moving at least one of one or more conduits into a lateral pipe off of the main pipe.

5. The method of claim 4, wherein the at least one of the one or more conduits is secured in-place to a wall of the lateral pipe.

6. The method of claim 1, further comprising bundling together a plurality of conduits to comprise the one or more conduits before inserting the conduits into the main pipe.

7. The method of claim 6, further comprising selectively unbundling at least one of the bundled conduits to move the at least one unbundled conduit into and through a lateral pipe.

8. The method of claim 1, wherein the curable material comprises one or more of:
a. a resin impregnated liner section having a length less than the length of the main or lateral pipe;
b. a resin impregnated liner extending approximately the full length of the main or lateral pipe; or
c. a curable resin positioned directly to the main or lateral pipe.

9. The method of claim 8, further comprising spacing a number of resin impregnated liner sections having a length less than the length of the main or lateral pipes along the length of the main or lateral pipes, and expanding a bladder at the sections to cure the sections and secure the one or more conduits in place.

10. The method of claim 8, wherein the resin impregnated liner is inverted into the main or lateral pipes.

11. The method of claim 1, wherein when the curable resin is positioned directly to the main or lateral pipe, an inverting bladder is positioned in the pipe to hold the resin in place until it is cured.

12. A system for positioning one or more conduits in a pipe system, the system comprising:
one or more elongated conduits for positioning in the pipe system;
a tape comprising a curable material; and
a robotic member, said robotic member applying at least a portion of the tape comprising the curable resin to a portion of the pipe system with the one or more elongated conduits positioned between the tape and the pipe system.

13. The system of claim 12, wherein the robotic member further comprises a curing element used to cure the curable material.

14. The system of claim 13, wherein the robotic element further comprises an inflatable member to hold the tape and one or more conduits towards the pipe during curing.

15. A method of installing one or more conduits through a pipe system comprising a main pipe and one or more lateral pipes extending from the main pipe, the method comprising:
introducing the one or more conduits into the main pipe;
moving the one or more conduits through the main pipe;
at a lateral pipe extending from the main pipe, inserting at least one of the one or more conduits into and through the lateral pipe, wherein any remaining of the one or more conduits continue through the main pipe;
applying a curable material to the one or more conduits in the main and lateral pipes; and
pressing the curable material and the one or more conduits towards a wall of the main and lateral pipes until the curable material cures and hardens to secure in-place the one or more conduits in place at the wall of the main or lateral pipe.

16. The method of claim 15, further comprising repairing the main or lateral pipe with a CIPP liner.

17. The method of claim 15, wherein the curable material comprises a thermoset resin or cementitious material.

18. The method of claim 17, further comprising inverting the resin impregnated liner into the main and/or lateral pipes with an inflatable bladder to press the resin impregnated liner and one or more conduits towards the wall of the pipes.

19. The method of claim 18, further comprising installing a gasket at a junction between the main and lateral pipe after the one or more conduits have been inserted into the lateral pipe.

20. The method of claim 15, wherein the curable material comprises one or more of:
a. a resin impregnated liner section having a length less than the length of the main or lateral pipe;
b. a resin impregnated liner extending approximately the full length of the main or lateral pipe; or
c. a curable resin positioned directly to the main or lateral pipe.

21. A method of installing one or more conduits in a pipe, the method comprising:
inserting one or more conduits into and through a pipe;
navigating the one or more conduits around any openings or obstructions in the pipe; and
securing the one or more conduits at or near a wall of the pipe by applying a curable material such that the one or more conduits are between the curable material and the wall of the pipe and allowing the curable material to cure and harden to hold the one or more conduits in place.

22. The method of claim 21, further comprising pressing the curable material towards the wall of the pipe during curing to provide a smoother interior surface once cured and hardened.

23. The method of claim 21, wherein the curable material is applied continuously along the length of the pipe.

24. The method of claim 21, wherein the curable material is selectively spaced non-continuous along the length of the pipe.

25. A method of installing one or more conduits in a pipe, comprising:
creating a groove or indention in a wall of the pipe;
positioning one or more conduits into the groove or indention in the wall of the pipe; and
securing the one or more conduits in-place in the groove in a non-mechanical manner.

26. The method of claim 25, further comprising adding a layer of curable material over the one or more conduits in the groove or indention in the wall of the pipe, and curing the material to secure.
